(19) United States
(12) Patent Application Publication
(10) Pub. No.: US 2026/0011519 A1
(43) Pub. Date: Jan. 8, 2026

(54) SOLID-STATE CIRCUIT BREAKER

(71) Applicant: Schneider Electric Industries SAS, Rueil Malmaison (FR)

(72) Inventor: Yang HU, Shanghai (CN)

(21) Appl. No.: 19/259,951

(22) Filed: Jul. 3, 2025

(30) Foreign Application Priority Data
Jul. 5, 2024 (CN) 202410904733.1

(51) Int. Cl. H01H 71/12; H01H 71/02; H01H 71/52

(52) U.S. Cl. CPC H01H 71/123; H01H 71/0207; H01H 71/52

(57) ABSTRACT

The present disclosure provides a solid-state circuit breaker, which includes: a housing; a contact assembly; a semiconductor element, connected in series with the contact assembly; a handle; a first microswitch, capable of being triggered to generate a first signal; a second microswitch, capable of being triggered to generate a second signal; a first trigger part, coupled to the handle to move the handle; and a second trigger part, coupled to the handle to move with the handle, wherein, during a movement of the handle from the closed position to the open position, before the contact assembly is switched to the open state, the first microswitch generates the first signal, during a movement of the handle from the open position to the closed position, before the contact assembly is switched to the closed state, the second microswitch generates the second signal.

The present disclosure claims the priority and benefits of the Chinese Patent Applications No. 202410904733.1, which was filed on Jul. 5, 2024, the disclosure of which is incorporated herein by reference in its entirety as part of the present disclosure.

### TECHNICAL FIELD

The present disclosure relates to the electrical field, in particular to a solid-state circuit breaker.

### BACKGROUND

Solid-state circuit breaker is a circuit breaker which can connect mechanical isolation breakpoint module and circuit electronic module in series. It can realize circuit breaking through a semiconductor component and provide circuit isolation through mechanical breakpoints, which has the advantages of short breaking time and no arc generation during breaking. However, in order to ensure the function realization of solid-state circuit breaker, there are additional requirements for the solid-state circuit breaker.

For example, in the case of the solid-state circuit breaker being manually opened, in order to ensure that no arc is generated, it is needed to ensure that the electronic module is separated first and the contact assembly is separated then. Therefore, the electronic module of the solid-state circuit breaker needs to recognize in advance that the customer is carrying out manual switching, and control the semiconductor element to cut off the circuit, so as to ensure that the contact assembly is in a state of no electricity and no arc is generated upon it is separated.

For example, in the case of the solid-state circuit breaker being manually closed, in order to prevent an external circuit from being reversely connected or generating large current at the moment of closing, which may cause harm to the electronic components on the circuit and the safety of the customer, it is also needed to identify in advance that the customer is manually closing, and detect the circuit and take protective measures before the contact assembly contact.

Therefore, there is a need for a solid-state circuit breaker that can solve the above problems.

### SUMMARY

The purpose of the present disclosure is to at least solve the shortcomings existing in the existing art. The present disclosure provides a solid-state circuit breaker, including a housing; a contact assembly, configured to switch between an open state and a closed state, the contact assembly being off in the open state and conductive in the closed state; a semiconductor element connected in series with the contact assembly; a handle, configured to move between an open position and a closed position, and the contact assembly is switched to an open state upon the handle moving to the open position and the contact assembly is switched to the closed state upon the handle moving to the closed position; a first microswitch, fixed to the housing and capable of being triggered to generate a first signal; a second microswitch, fixed to the housing and capable of being triggered to generate a second signal; a first trigger part coupled to the handle to move along with a movement of the handle; a second trigger part coupled to the handle to move with the movement of the handle.

During a movement of the handle from the closed position to the open position, before the contact assembly is switched to the open state, the first trigger part triggers the first microswitch to generate the first signal; during a movement of the handle from the open position to the closed position, before the contact assembly is switched to the closed state, the second trigger part triggers the second microswitch to generate the second signal.

Therefore, the solid-state circuit breaker according to the present disclosure can recognize an opening operation before the contact assembly separates during the opening operation of the handle, and output the corresponding first signal, and can recognize an closing operation before the contact assembly contacts and conducts during the closing operation of the handle, and output the corresponding second signal. Therefore, sufficient reaction time can be provided for the required function or step to realize the function or step before a mechanical opening and a mechanical closing of the contact assembly, for example, to realize the electronic opening of the semiconductor element before the mechanical opening of the contact assembly, so as to meet the additional requirements for the solid-state circuit breaker.

For example, in some embodiments of the present disclosure, during the movement of the handle from the closed position to the open position, before the contact assembly is switched to the open state, a pressed stroke of the first trigger part on the first microswitch is changed, thereby triggering the first microswitch to generate the first signal.

During the movement of the handle from the open position to the closed position, before the contact assembly is switched to the closed state, a pressed stroke of the second trigger part on the second microswitch is changed, thereby triggering the second microswitch to generate the second signal.

For example, in some embodiments of the present disclosure, the handle is mounted to pivot around a pivot shaft, the first trigger part and the second trigger part are fixed to the handle.

The first trigger part comprises a first section and a second section which are adjacent to each other, a distance between a point on the first section and the pivot shaft is smaller than a distance between a point on the second section and the pivot shaft, during the movement of the handle from the closed position to the open position, a position where the first microswitch and the first trigger part abut against each other moves from the first section to the second section.

The second trigger part comprises a third section and a fourth section which are adjacent to each other, and a distance between a point on the third section and the pivot shaft is smaller than a distance between a point on the fourth section and the pivot shaft, during the movement of the handle from the open position to the closed position, a position where the second microswitch and the second trigger part abut against each other moves from the third section to the fourth section.

For example, in some embodiments of the present disclosure, the first trigger part and the first microswitch are configured such that: during that movement of the handle from the closed position to the open position, a pressed stroke of the first microswitch by the first section is increased from a value less than a first threshold to a value greater than a second threshold, and a pressed stroke of the first microswitch by the second section is greater than the second threshold and less than a third threshold, in the case of the pressed stroke of the first microswitch being less than a first threshold, the first microswitch is kept in a first state, in the case of the pressed stroke of the first microswitch being greater than a second threshold, the first microswitch is kept in a second state, in the case of the pressed stroke of the first microswitch being less than a third threshold, the first microswitch is not damaged, the first signal is that the first microswitch changes from the first state to a second state.

The second trigger part and the second microswitch are configured such that: a pressed stroke of the second microswitch by the fourth section is less than a fourth threshold, and, during the movement of the handle from the open position to the closed position, a pressed stroke of the second microswitch by the third section is reduced from a value greater than a fifth threshold and less than a sixth threshold to a value less than the fourth threshold, in the case of the pressed stroke of the second microswitch being less than the fourth threshold, the second microswitch is kept in a third state, in the case of the pressed stroke of the second microswitch being greater than the fifth threshold, the second microswitch is kept in a fourth state, in the case of the pressed stroke of the second microswitch being less than the sixth threshold, the second microswitch is not damaged, the second signal is that the second microswitch changes from the fourth state to the third state.

For example, in some embodiments of the present disclosure, the first microswitch and the second microswitch are normally open microswitches, and the first state and the third state are open-circuit states, and the second state and the fourth state are closed-circuit states.

For example, in some embodiments of the present disclosure, during the movement of the handle from the closed position to the open position, the first microswitch is switched the state earlier than the second microswitch.

For example, in some embodiments of the present disclosure, the first microswitch and the second microswitch are configured such that directions in which the first microswitch and the second microswitch are pressed and actuated are opposite in a radial direction of the pivot shaft.

For example, in some embodiments of the present disclosure, the first trigger part and the second trigger part are two sections of a trigger element, the trigger element is provided with a correction part adjacent to the first trigger part along an extension direction of the pivot shaft, and a distance between the correction part and the pivot shaft is greater than a distance of the first section and the pivot shaft, and the correction part comprises an inclined surface inclined toward the first section along an extension direction of the first section.

For example, in some embodiments of the present disclosure, the solid-state circuit breaker further comprises a detection unit, and the detection unit detects whether a circuit connected to the solid-state circuit breaker is reversely connected after receiving the second signal, and in response to the detection unit detecting that circuit is reversely connected, the solid-state circuit breaker is tripped before the contact assembly is switched to the closed state.

For example, in some embodiments of the present disclosure, the first microswitch and the second microswitch are the same.

For example, in some embodiments of the present disclosure, the semiconductor element is switched from a conductive state to a off state according to the first signal before the contact assembly is switched to the open state.

### BRIEF DESCRIPTION OF DRAWINGS

FIG. 1 shows a plan view of an internal structure of a solid-state circuit breaker according to an embodiment of the present disclosure, in which a handle is located between a closed position and an open position;

FIG. 2 shows a perspective view of a trigger element according to the present disclosure;

FIG. 3 shows a plan view of an internal structure of a solid-state circuit breaker shown in FIG. 1, in which the handle is located at the closed position;

FIG. 4 shows a plan view of an internal structure of a solid-state circuit breaker shown in FIG. 1, in which the handle is located at the open position;

FIGS. 5a-5c are partial schematic diagrams sequentially showing changes in the internal structure of the solid-state circuit breaker of FIG. 1 during a movement of the handle from the closed position to the open position;

FIGS. 6a-6b are partial schematic diagrams sequentially showing changes in the internal structure of the solid-state circuit breaker of FIG. 1 during a movement of the handle from the open position to the closed position;

FIG. 7 is a partial perspective view showing an engagement of a trigger element with a first microswitch and a second microswitch.

### REFERENCE NUMERALS

1—handle;
21—first microswitch, 22—second microswitch;
3—trigger element, 31—first trigger part, 311—first section, 312—second section, 32—second trigger part;
4—housing.

### DETAILED DESCRIPTION

In order to make the purpose, technical details and advantages of the technical solution of the present disclosure more clear, the technical solution of the embodiment of the present disclosure will be described clearly and completely with the accompanying drawings of specific embodiments of the present disclosure. Unless otherwise specified, the terms used herein have the ordinary meaning in the art. Like reference numerals in the drawings represent like parts.

In the description of the present disclosure, it should be noted that unless otherwise specified and limited, the terms “installation”, “connection” and “connect” should be broadly understood, for example, they can be fixed connection, detachable connection or integrated connection; they can be mechanical connection or electrical connection; they can be direct connection, can also be indirectly connection through an intermediate medium, and can be interconnection of interiors of two elements. For those skilled in the art, the specific meanings of the above terms in the present disclosure can be understood in specific situations.

The present disclosure proposes a solid-state circuit breaker, which may include a contact assembly (not shown), which may include, for example, a movable contact and a stationary contact, and the contact assembly may be switched between an open state and a closed state. In the case of the contact assembly being in the open state, the movable contact and the stationary contact are separated from each other, and the contact assembly is off; and in the case of the contact assembly being in the closed state, the movable contact and the stationary contact are in contact with each other, and the contact assembly is conductive.

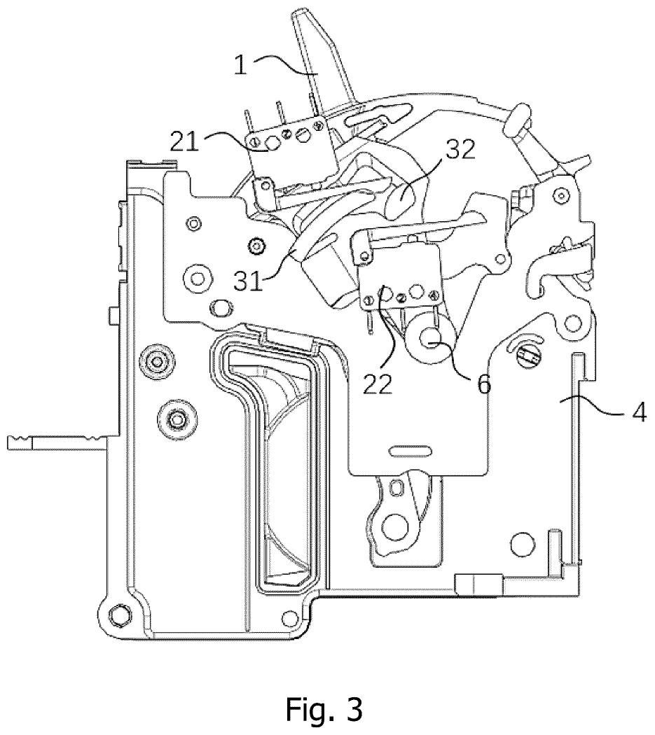

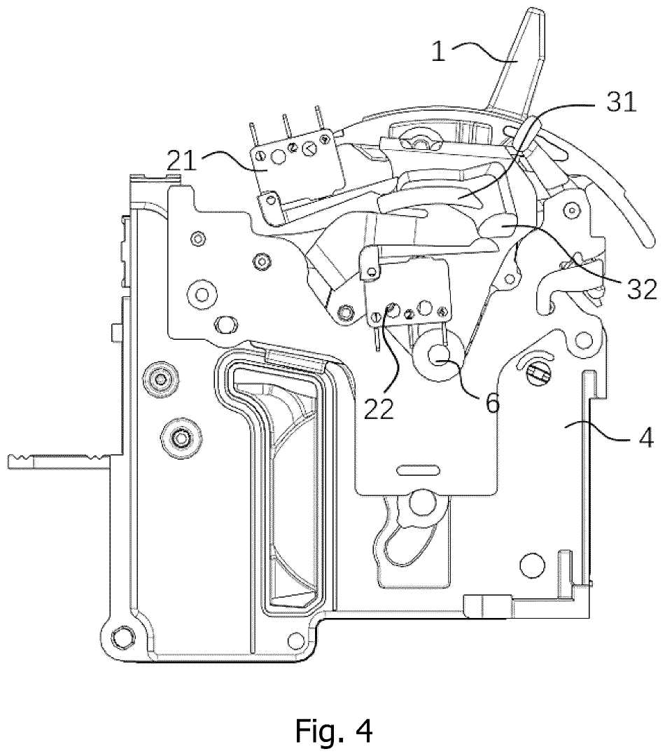

In particular, the contact assembly can be driven by a handle 1 (for example, through a linkage mechanism not shown) to switch between an open state and a closed state, and the handle 1 is able to pivot relative to the housing 4, especially relative to a pivot shaft 6. The handle 1 is able to move between an open position (as illustrated by FIG. 4) and a closed position (as illustrated by FIG. 3). Upon the handle 1 moving to the open position, the contact assembly is switched to the open state, and upon the handle 1 moving to the closed position, the contact assembly is switched to the closed state.

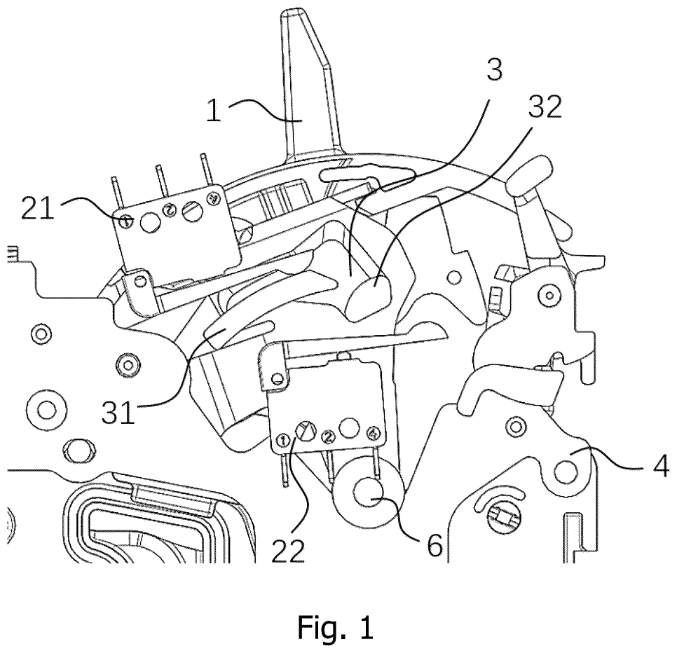

The solid-state circuit breaker of the present disclosure is designed to be able to detect the operation of the handle 1, whereby the solid-state circuit breaker is further provided with a first microswitch 21 and a second microswitch 22 fixed to the housing 4. Identification of the operation of the handle 1 is indicated by specific triggering of the first microswitch 21 and the second microswitch 22. Specifically, the first microswitch 21 can be triggered to generate a first signal, and the second microswitch 22 can be triggered to generate a second signal. In particular, the first signal and the second signal can be state changes of the first microswitch 21 and the second microswitch 22, respectively. For example, the first microswitch 21 can be switched from a first state to a second state, and the second microswitch 22 can be switched from a third state to a fourth state. The state changes can be, for example, from an open-circuit state to a closed-circuit state or from a closed-circuit state to an open-circuit state, respectively. In particular, according to the embodiment shown in FIG. 1, the first state and the third state may be open-circuit states, and the second state and the fourth state may be closed-circuit states.

In addition, the first microswitch 21 and the second microswitch 22 may be normally open or normally closed, respectively. The state changes of the first microswitch 21 and the second microswitch 22 can be realized by the actuations they receive, such as pulling, pressing, turning, etc. For example, the first microswitch 21 and the second microswitch 22 shown in FIG. 1 change their states according to pressed stroke. For example, both the first microswitch 21 and the second microswitch 22 shown in FIG. 1 can be normally open, and they can be switched from open-circuit states to closed-circuit states in the case of pressed strokes of both microswitches exceed certain thresholds. For example, in the embodiments shown in FIGS. 1, 3 and 4, the first signal may be a state change from an open-circuit state to a closed-circuit state, and the second signal may be a state change from a closed-circuit state to an open-circuit state.

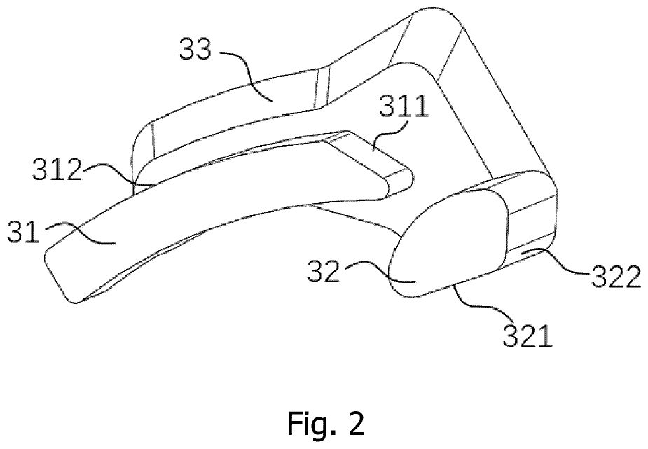

The solid-state circuit breaker of the present disclosure can trigger the first microswitch 21 and the second microswitch 22 respectively by setting a first trigger part 31 and a second trigger part 32, and especially change the states of the first microswitch 21 and the second microswitch 22 by pressing. The first trigger part 31 and the second trigger part 32 may be coupled to the handle 1 to move with the movement of the handle 1. In particular, the first trigger part 31 and the second trigger part 32 may be fixed to the handle 1 to pivot around the pivot shaft 6 together with the handle 1. Through direct fixation, the time delay caused by the intermediate coupling mechanism can be reduced, so that the closing operation or opening operation of the handle can be captured and identified more quickly and timely, the accuracy and agility of capturing and identifying can be ensured, and more reaction time can be reserved for identifying subsequent steps or functions. Further, as illustrated by FIG. 2, the first trigger part 31 and the second trigger part 32 may be two sections of a trigger element 3, such as sections spaced apart from each other.

For example, as illustrated by FIG. 1, the first microswitch 21 and the second microswitch 22 are configured such that the directions in which the first microswitch 21 and the second microswitch 22 are pressed and actuated are opposite in a radial direction of the pivot shaft 6, that is, the first microswitch 21 and the second microswitch 22 are respectively arranged on both sides of the trigger element 3 in the radial direction of the pivot shaft 6. Therefore, the internal arrangement of the solid-state circuit breaker can be more compact, which is beneficial to the miniaturization of the solid-state circuit breaker.

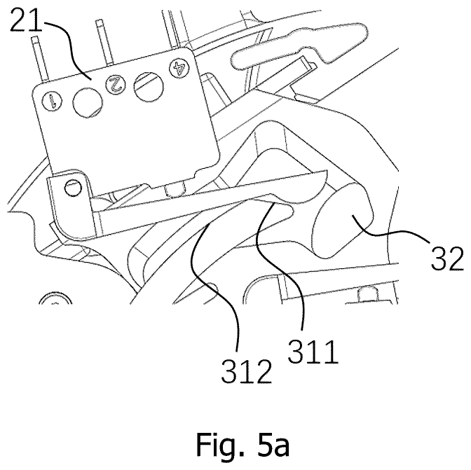

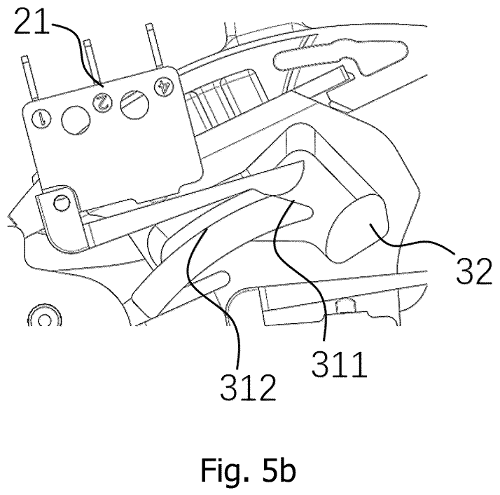

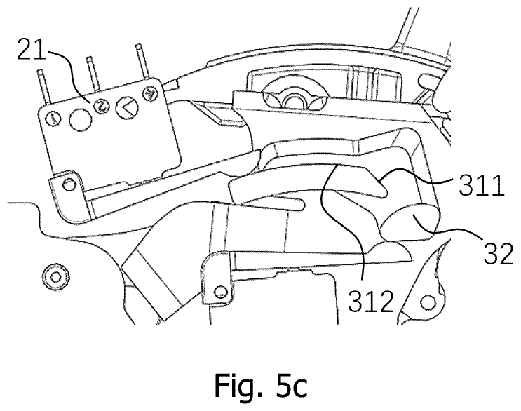

In particular, the structures and positions of the first trigger part 31 and the first microswitch 21 can be configured such that during a movement of the handle 1 from the closed position (shown in FIG. 3) to the open position (shown in FIG. 4), before the contact assembly is switched to the open state, the first trigger part 31 triggers the first microswitch 21 to generate a first signal, for example, to switch the first microswitch 21 from the open-circuit state to the closed-circuit state. In particular, the generation of the first signal is realized by changing the pressed stroke of the first microswitch, for example, increasing the pressed stroke, as illustrated by FIGS. 5a-5c.

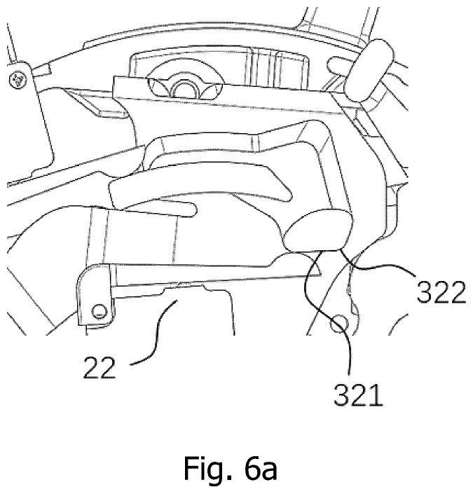

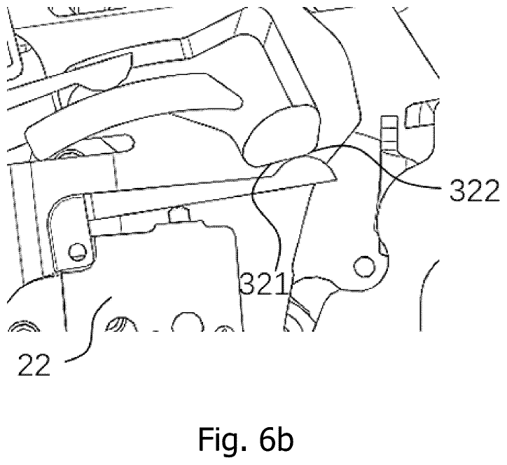

In particular, the structure and position of the second trigger part 32 and the second microswitch 22 can be configured such that during the movement of the handle 1 from the open position (shown in FIG. 4) to the closed position (shown in FIG. 3), before the contact assembly is switched to the closed state, the second trigger part 32 triggers the second microswitch 22 to generate a second signal, for example, to switch the second microswitch 21 from the closed-circuit state to the open-circuit state. In particular, the generation of the second signal is realized by changing the pressed stroke of the second microswitch, for example, reducing the pressed stroke, as illustrated by FIGS. 6a-6b.

Therefore, the solid-state circuit breaker according to the present disclosure can recognize the opening operation before the contact assembly separates during the opening operation of the handle, and output the corresponding first signal, and can recognize the closing operation before the contact assembly contacts and conducts during the closing operation of the handle, and output the corresponding second signal. Therefore, sufficient reaction time can be provided for the required function or step to realize the function or step before the mechanical opening and mechanical closing of the contact assembly, for example, the electronic opening of the semiconductor element can be realized before the mechanical opening of the contact assembly, and whether the circuit connected to the solid-state circuit breaker is abnormal or not can be detected before the mechanical closing of the contact assembly, so as to meet the additional requirements for the solid-state circuit breaker.

As illustrated by FIG. 2, the first trigger part 31 includes a first section 311 and a second section 312, the first section 311 and the second section 312 may refer to, for example, two surfaces that contact and abut against the first microswitch 21. For example, as illustrated by FIG. 2, the first section 311 may be a flat surface, and the second section 312 may be a curved surface, such as an arc surface, especially the center of the arc may be on the pivot shaft 6, as illustrated by FIG. 1. Further, as illustrated by FIG. 1, the first trigger part 31 is fixed to a position such that a distance between a point on the first section 311 and the pivot shaft 6 is smaller than a distance between a point on the second section 312 and the pivot shaft 6. As illustrated by FIGS. 5a-5c, during the movement of the handle 1 from the closed position to the open position, a position where the first microswitch 21 and the first trigger part 31 abut against each other moves from the first section 311 to the second section 312, thereby increasing the pressed stroke of the first microswitch 21, so that the first microswitch 21 switches from the open-circuit state to the closed-circuit state, and generates the first signal.

As illustrated by FIG. 2, the second trigger part 32 includes a third section 321 and a fourth section 322, the third section 321 and the fourth section 322 may refer to, for example, two surfaces that contact and abut against the second microswitch 22. For example, as illustrated by FIG. 2, the third section 321 may be a flat surface, and the fourth section 322 may be a curved surface, such as an arc surface. Further, as illustrated by FIG. 1, the second trigger part 32 is fixed such that a distance between a point on the third section 321 and the pivot shaft 6 is smaller than a distance between a point on the fourth section 322 and the pivot shaft 6. As illustrated by FIGS. 6a-6b, during a movement of the handle 1 from the open position to the closed position, a position where the second microswitch 22 and the second trigger part 32 abut against each other moves from the third section 321 to the fourth section 322, thereby reducing the pressed stroke of the second microswitch 22, so that the second microswitch 22 switches from the closed-circuit state to the open-circuit state and generates the second signal.

Therefore, through the simple special-shaped cam design, the identification of the closing and opening operation of the handle can be realized reliably and stably, and the cost is low and the volume is small.

Further, in order to trigger the first microswitch and the second microswitch more reliably and stably, it is needed to consider the manufacturing errors of the first microswitch 21 and the second microswitch 22. For example, for a certain type of microswitch, it usually has several ranges or thresholds, the ranges or thresholds are provided by the manufacturer, for example, and are extremely related to the selection of microswitches. For example, for a certain type of microswitch, the actuated (e.g., pressed) stroke at which the microswitch just changes state falls within a certain range. In the case of the actuated stroke of the this type of microswitch being less than the minimum end point of this range, it refers to that the microswitch of this type always remains in the non-switching state; in the case of the actuated stroke of this type of microswitch being greater than the maximum end point of the range, it refers to that this type of microswitch will definitely be switched. In addition, for this particular type of microswitch, there is usually a critical value, and in the case of the actuation stroke is greater than this critical value, this type of microswitch has the risk of being damaged.

Therefore, it is needed to configure the first microswitch 21 and the first trigger part 31 in consideration of the above parameters to ensure reliable and stable triggering. Specifically, a first threshold, a second threshold and a third threshold can be set for the first microswitch 21, for example, the first threshold is smaller than the second threshold and smaller than the third threshold, the first threshold can be smaller than or equal to the minimum endpoint of the above-mentioned range of a type corresponding to the first microswitch 21, the second threshold can be larger than or equal to the maximum endpoint of the above-mentioned range of the type corresponding to the first microswitch 21, and the third threshold can be smaller than or equal to the above-mentioned critical value of the type corresponding to the first microswitch 21. Thus, in the case of the pressed stroke of the first microswitch 21 being less than the first threshold, the first microswitch 21 remains in a first state, such as an open-circuit state; in the case of the pressed stroke of the first microswitch 21 being greater than the second threshold, the first microswitch 21 is kept in a second state, such as a closed-circuit state; in the case of the pressed stroke of the first microswitch 21 being less than the third threshold, the first microswitch 21 is not damaged.

Further, the first trigger part 31 and the first microswitch 21 are configured such that, during the movement of the handle 1 from the closed position to the open position, a pressed stroke of the first microswitch 21 by the first section 311 increases from a value less than a first threshold to a value greater than a second threshold, as illustrated by FIGS. 5a-5b; and a pressed stroke of the first microswitch 21 by the second section 312 is greater than the second threshold and less than the third threshold, as illustrated by FIG. 5c. Therefore, it is ensured that the first microswitch 21 is kept in the open-circuit state upon the handle is in the closed position, and the first section 311 completes the state change of the first microswitch 21 during the movement from the closed position to the open position, and then the first microswitch is kept in the closed-circuit state upon the second section 312 comes into contact with the first microswitch 21. In addition, during the whole process, the first microswitch 21 is not damaged by excessive pressing of the first trigger part 31.

Similarly, it is needed to configure the second microswitch 22 and the second trigger part 32 in consideration of the above parameters to ensure reliable and stable triggering. Specifically, a fourth threshold, a fifth threshold and a third threshold can be set for the second microswitch 22, for example, the fourth threshold is smaller than the fifth threshold and smaller than the sixth threshold, the fourth threshold can be smaller than or equal to the minimum endpoint of the above-mentioned range of the type corresponding to the second microswitch 22, the fifth threshold can be larger than or equal to the maximum endpoint of the above-mentioned range of the type corresponding to the second microswitch 22, and the sixth threshold can be smaller than or equal to the above-mentioned threshold of the model corresponding to the second microswitch 22. Thus, in the case of the pressed stroke of the second microswitch 22 being less than the fourth threshold, the second microswitch 22 remains in a third state, such as an open-circuit state; in the case of the pressed stroke of the second microswitch 22 being greater than the fifth threshold, the second microswitch 22 remains in a fourth state, such as a closed-circuit state; in the case of the pressed stroke of the second microswitch 22 being less than the sixth threshold, the second microswitch 22 is not damaged.

Further, the second trigger part 32 and the second microswitch 22 are configured such that, during the movement of the handle 1 from the open position to the closed position, the pressed stroke of the second microswitch 22 by the third section 321 is reduced from a value greater than the fifth threshold and less than the sixth threshold to a value less than the fourth threshold, as illustrated by FIGS. 6a-6b; and the pressed stroke of the second microswitch 22 by the fourth section 322 is less than the fourth threshold. Therefore, it is ensured that the second microswitch 22 is kept in the closed-circuit state upon the handle being in the open position, during the movement of the handle from the open position to the closed position, the third section 321 completes the state change of the second microswitch 22, and then the fourth section 312 contact and abut against the second microswitch 22, and keep the second microswitch 22 in the open-circuit state. And, in the whole process, the second microswitch 22 is not damaged by excessive pressing of the second trigger part 32.

Preferably, upon the handle 1 moving from the closed position to the open position, the first microswitch 21 can be switched the state earlier than the second microswitch 22. For example, as illustrated by FIGS. 1 and 5b, the first microswitch 21 is pressed and the second microswitch 22 is not pressed. According to this configuration, the position of the handle upon the first signal being output is closer to the closed position, and the position of the handle upon the second signal being output is closer to the open position, so that the operation of the handle can be recognized earlier and more timely, and more sufficient reaction time can be provided for the recognized steps or functions.

Especially for the first microswitch 21 and the second microswitch 22 mentioned above, they can be the same, that is, the same type is selected, so that the design and assembly can be simplified and the manufacturing cost can be reduced.

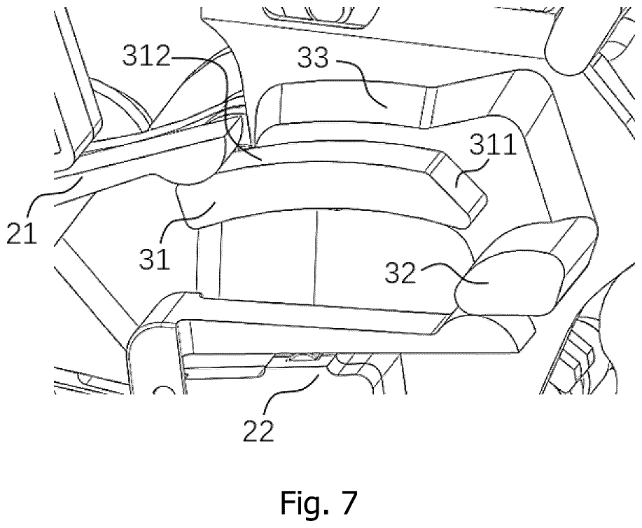

Further, in the actual use of the solid-state circuit breaker, the first microswitch 21 and the first trigger part 31 are staggered along an extension direction of the pivot shaft 6, that is, the first microswitch 21 and the first trigger part 31 may be located in different planes, so that they cannot contact each other, thus affecting the stable trigger of the first microswitch 21. For this reason, the trigger element 3 is also provided with a correction part 33, as illustrated by FIG. 2, the correction part 33 is, for example, a curved surface, for example, composed of a plurality of surface sections, as illustrated by FIGS. 1 and 7. The correction part 33 is adjacent to the first trigger part 31 in the direction of the pivot shaft 6, and a distance between the correction part 33 and the pivot shaft 6 is greater than a distance between the first section 311 and the pivot shaft 6. The correction part 33 includes an inclined surface inclined towards the first section 311 in the extension direction of the first section 311, the inclined surface does not overlap with the first section 311 in the direction of the pivot shaft, as illustrated by FIGS. 1 and 7. Through the inclined surface of the correction part 33, the first microswitch 21 staggered and deviated in the extension direction of the pivot shaft 6 can be guided to contact and abut against the first trigger part 31 again, thus playing a correcting role.

Additional functions can be realized by using the first signal and the second signal, such as ensuring the safety of the solid-state circuit breaker. For example, that solid-state circuit break according to the present disclosure further include a semiconductor element (not shown) connected in series with the above contact assembly. In particular, the semiconductor element can be switched from a conductive state to the off state according to the first signal before the contact assembly is switched to the open state. Therefore, the semiconductor element can be electrically off before the mechanical opening of the contact assembly, thereby ensuring that no arc is generated upon the contact assembly being off, and ensuring the safety of users.

For the second signal, for example, it can be received and responded by a detection unit (not shown) arranged in the solid-state circuit breaker. Upon the detection unit receiving the second signal, the detection unit can start a circuit inspection function, such as detecting whether the circuit connected to the solid-state circuit breaker is reversely connected or not (for example, detecting voltage values at both ends of the solid-state circuit breaker). In response to the circuit being reversely connected, for example, the solid-state circuit breaker can be tripped. Specifically, the solid-state circuit breaker according to the present disclosure is set in a DC circuit, for example. Because some electronic devices in the solid-state circuit breaker cannot withstand the reverse voltage, there are strict requirements for the positive and negative wiring at both ends of the solid-state circuit breaker. However, the wiring at both ends of the solid-state circuit breaker may often be reversed due to negligence, which will damage the solid-state circuit breaker, bring great cost loss and take time and effort to replace it. After the detection unit receives the second signal and detects the reverse connection, the solid-state circuit breaker trips, which can avoid the adverse effects caused by the reverse connection. Therefore, even if the handle moves to the closed position, the contact assembly will not conduct. Therefore, the safety of the solid-state circuit breaker can be greatly increased.

It should be understood that the above description is intended to be illustrative rather than limiting. For example, the above embodiments (and/or aspects thereof) may be used in combination with each other. In addition, many modifications may be made to adapt a particular situation or material to the teachings of the present disclosure without departing from its scope. The functions or performances of various elements or modules described herein are only for illustration and are in no way restrictive, but only exemplary embodiments. Many other embodiments and modifications within the spirit and scope of the claims will be apparent to those skilled in the art after reading the above description. Therefore, the scope of the present disclosure should be determined with reference to the appended claims, along with the full scope of equivalents to which such claims are entitled.

In the appended claims, the terms “including” and “in which” are used as simple English equivalents of the corresponding terms “containing” and “wherein”. Furthermore, in the following claims, the terms “first”, “second” and “third” are only used as labels, and no numerical requirements are intended to be imposed on their objects.

1. A solid-state circuit breaker, comprising
a housing;
a contact assembly, configured to switch between an open state and a closed state, the contact assembly being off in the open state and conductive in the closed state;
a semiconductor element, connected in series with the contact assembly;
a handle, configured to move between an open position and a closed position, wherein the contact assembly is switched to an open state upon the handle moving to the open position, and the contact assembly is switched to the closed state upon the handle moving to the closed position;
a first microswitch, fixed to the housing and capable of being triggered to generate a first signal;
a second microswitch, fixed to the housing and capable of being triggered to generate a second signal;
a first trigger part, coupled to the handle to move with a movement of the handle; and
a second trigger part, coupled to the handle to move with the movement of the handle,
wherein, during a movement of the handle from the closed position to the open position, before the contact assembly is switched to the open state, the first trigger part triggers the first microswitch to generate the first signal,
during a movement of the handle from the open position to the closed position, before the contact assembly is switched to the closed state, the second trigger part triggers the second microswitch to generate the second signal.

2. The solid-state circuit breaker according to claim 1, wherein,
during the movement of the handle from the closed position to the open position, before the contact assembly is switched to the open state, a pressed stroke of the first trigger part on the first microswitch is changed, thereby triggering the first microswitch to generate the first signal,
during the movement of the handle from the open position to the closed position, before the contact assembly is switched to the closed state, a pressed stroke of the second trigger part on the second microswitch is changed, thereby triggering the second microswitch to generate the second signal.

3. The solid-state circuit breaker according to claim 2, wherein,
the handle is mounted to pivot around a pivot shaft, and the first trigger part and the second trigger part are fixed to the handle;
wherein the first trigger part comprises a first section and a second section which are adjacent to each other, a distance between a point on the first section and the pivot shaft is smaller than a distance between a point on the second section and the pivot shaft, during the movement of the handle from the closed position to the open position, a position where the first microswitch and the first trigger part abut against each other moves from the first section to the second section;
wherein the second trigger part comprises a third section and a fourth section which are adjacent to each other, and a distance between a point on the third section and the pivot shaft is smaller than a distance between a point on the fourth section and the pivot shaft, during the movement of the handle from the open position to the closed position, a position where the second microswitch and the second trigger part abut against each other moves from the third section to the fourth section.

4. The solid-state circuit breaker according to claim 3, wherein,
the first trigger part and the first microswitch are configured such that:
during the movement of the handle from the closed position to the open position, a pressed stroke of the first microswitch by the first section is increased from a value less than a first threshold to a value greater than a second threshold,
and a pressed stroke of the first microswitch by the second section is greater than the second threshold and less than a third threshold,
in the case of the pressed stroke of the first microswitch being less than a first threshold, the first microswitch is kept in a first state,
in the case of the pressed stroke of the first microswitch being greater than a second threshold, the first microswitch is kept in a second state,
in the case of the pressed stroke of the first microswitch being less than a third threshold, the first microswitch is not damaged,
the first signal is that the first microswitch changes from the first state to the second state;
the second trigger part and the second microswitch are configured such that:
a pressed stroke of the second microswitch by the fourth section is less than a fourth threshold,
and, during the movement of the handle from the open position to the closed position, a pressed stroke of the second microswitch by the third section is reduced from a value greater than a fifth threshold and less than a sixth threshold to a value less than the fourth threshold,
in the case of the pressed stroke of the second microswitch being less than the fourth threshold, the second microswitch is kept in a third state,
in the case of the pressed stroke of the second microswitch being greater than the fifth threshold, the second microswitch is kept in a fourth state,
in the case of the pressed stroke of the second microswitch being less than the sixth threshold, the second microswitch is not damaged,
the second signal is that the second microswitch changes from the fourth state to the third state.

5. The solid-state circuit breaker according to claim 4, wherein,
first state and the third state are open-circuit states, and the second state and the fourth state are closed-circuit states.

6. The solid-state circuit breaker according to claim 4, wherein,
during the movement of the handle from the closed position to the open position, the first microswitch is switched the state earlier than the second microswitch.

7. The solid-state circuit breaker according to claim 3, wherein,
the first microswitch and the second microswitch are configured such that directions in which the first microswitch and the second microswitch are pressed and actuated are opposite in a radial direction of the pivot shaft.

8. The solid-state circuit breaker according to claim 3, wherein,
the first trigger part and the second trigger part are two sections of a trigger element,
the trigger element is provided with a correction part adjacent to the first trigger part along an extension direction of the pivot shaft, and a distance between the correction part and the pivot shaft is greater than a distance of the first section and the pivot shaft, and the correction part comprises an inclined surface inclined toward the first section along an extension direction of the first section.

9. The solid-state circuit breaker according to claim 1, wherein,
the solid-state circuit breaker further comprises a detection unit, and the detection unit detects whether a circuit connected to the solid-state circuit breaker is reversely connected after receiving the second signal, and in response to the detection unit detecting that circuit is reversely connected, the solid-state circuit breaker is tripped before the contact assembly is switched to the closed state.

10. The solid-state circuit breaker according to claim 1, wherein,
the first microswitch and the second microswitch are the same.

11. The solid-state circuit breaker according to claim 10, wherein,
the semiconductor element is switched from a conductive state to an off state before the contact assembly is switched to the open state according to the first signal.
